(19) United States
(12) Patent Application Publication
(10) Pub. No.: US 2022/0322653 A1
(43) Pub. Date: Oct. 13, 2022

(54) ANIMAL TRAP

(71) Applicants: Dan Lay, 150 Mile House (CA); Kyle Lay, 150 Mile House (CA)

(72) Inventors: Dan Lay, 150 Mile House (CA); Kyle Lay, 150 Mile House (CA)

(21) Appl. No.: 17/224,346

(22) Filed: Apr. 7, 2021

(51) Int. Cl. A01M 23/26

(52) U.S. Cl. CPC A01M 23/265

(57) ABSTRACT

An animal trap that is configured to have adjustable tension so as to provide an ability to adjust the force of the trap based on the intended species targeted by a user of the trap. The animal trap includes a frame having a first portion and second portion that are u-shaped and movably coupled to opposing ends of a support bar. The present invention includes a first spring assembly and a second spring assembly that are configured to provide operation of the animal trap. The trap includes an engagement member that is configured to couple to an upper surface of the frame so as to hold the trap of the present invention in a ready position. The shafts of the spring assemblies are rotatably secured so as to provide rotational positional adjustment thereof for altering tension of the springs. Lever portions are contiguously formed with the springs.

### FIELD OF THE INVENTION

The present invention relates generally to animal trapping, more specifically but not by way of limitation, an animal trap that is configured to have elements enabling a user to have a greater degree of adjustability on the trap providing more options, improved efficiencies and effectiveness in the humane trapping of animals for purposes such as but not limited to livestock protection, human and domestic animal protection as well as research studies.

### BACKGROUND

As is known in the art, animal trapping is executed for a variety of purposes. Some trapping is executed as a means of catching an animal for processing purposes while other trapping is focused on the protection of domestic livestock from predators. An example of the latter is the trapping of wolves to protect livestock such as but not limited to cattle. For the latter example the intended objective is to humanely trap the animal so as to capture and either relocate or address the animal as needed with reduced potential of harm to the animal. Basic animal traps have been in use for hundreds of years but the design has largely remained the same and is ineffective in the ability to target different species and promote the humane trapping of these animals.

One issue with conventional animal traps is the inability to adjust spring tension force. This results in the ability to configure the trap for a specific animal. As such the force may be too strong for the trapped animal resulting in harm thereto such as but not limited to a broken leg. Additionally, once trapped in a conventional trap the animal may perform movements that result in becoming more entangled in the equipment. This results in potentially more unintended injuries inflicted on the animal.

It is intended within the scope of the present invention to provide a live animal trap that is configured to trap an animal via clamping of a leg or foot wherein the present invention is configurable for different species and provides an improved ability to inhibit unintended harm to the trapped animal.

### SUMMARY OF THE INVENTION

It is the object of the present invention to provide a live animal trap that is configured to be adjusted towards trapping of a targeted species wherein the present invention includes an adjustable trigger weight tension so as to promote selective and more effective capture of intended targeted species.

Another object of the present invention is to provide an animal trap that is operable to provide live trapping of an animal compliant with humane capture regulations wherein the adjustable weight tension force is controlled via manipulation of angles and distance amongst the trap elements.

A further object of the present invention is to provide a live animal trap that is configured to be adjusted towards trapping of a targeted species wherein the present invention utilizes an adjustable spring to operate the jaw elements.

Still another object of the present invention is to provide an animal trap that is operable to provide live trapping of an animal compliant with humane capture regulations wherein the present invention further includes a safety release element.

An additional object of the present invention is to provide a live animal trap that is configured to be adjusted towards trapping of a targeted species wherein the clamping jaws of the present invention include lamination secured thereto.

Yet a further object of the present invention is to provide an animal trap that is operable to provide live trapping of an animal compliant with humane capture regulations wherein the jaw lamination is manufactured from square rod in order to maximize the clamping area resulting in less damage to the captured animal.

Another object of the present invention is to provide a live animal trap that is configured to be adjusted towards trapping of a targeted species that further includes an attachment chain configured to be rotatable three hundred and sixty degrees so as to maintain a desirable orientation in relation to the trap.

An alternate object of the present invention is to provide an animal trap that is operable to provide live trapping of an animal compliant with humane capture regulations wherein the u-bolts of the present invention retain a spring shaft to the base plate member.

Still a further object of the present invention is to provide a live animal trap that is configured to be adjusted towards trapping of a targeted species wherein the spring shaft is rotatably mounted so as to provide adjustment of the spring tension.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a detailed view of the engagement member of the present invention; and

FIG. 2 is a top view of the preferred embodiment of the present invention; and

FIG. 3 is a bottom view of the present invention; and

FIG. 4 is a detailed view of the engagement member of the present invention.

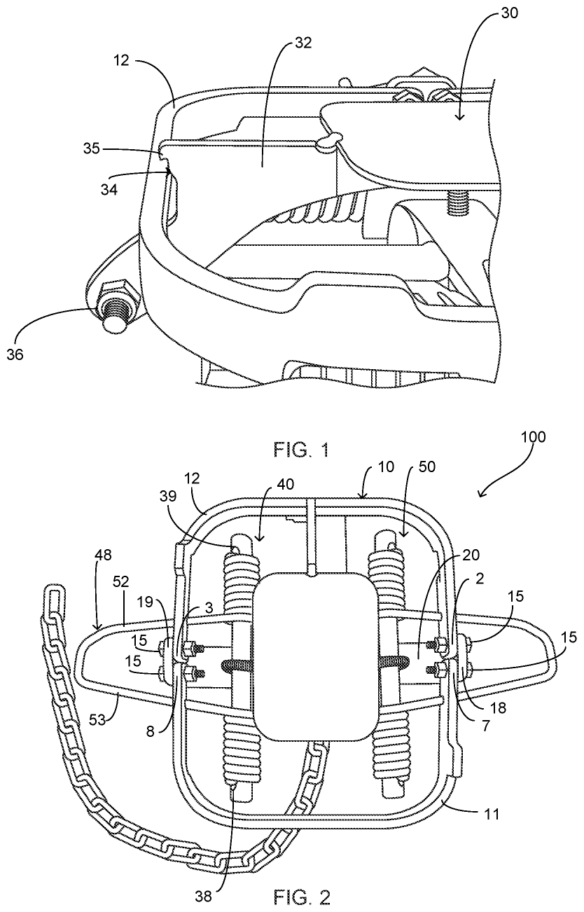

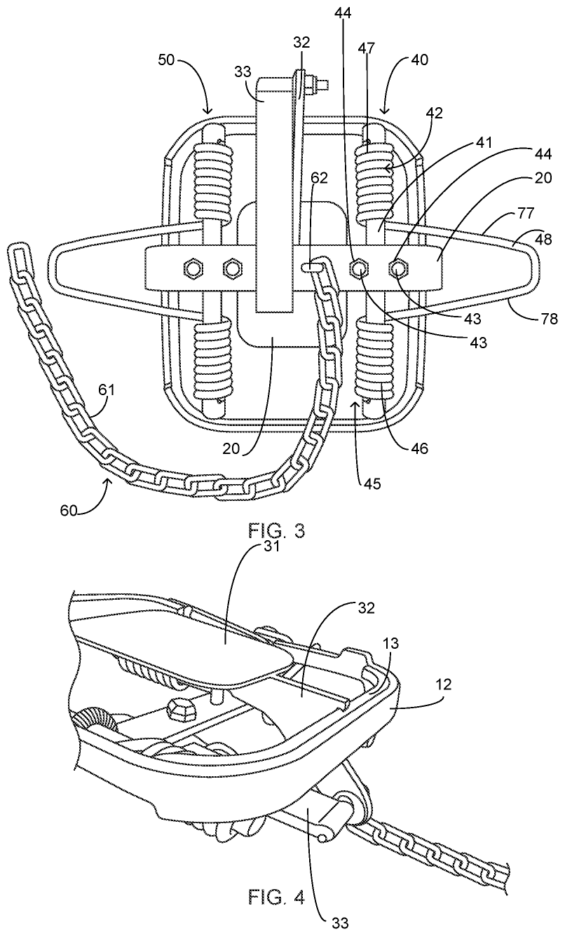

### DETAILED DESCRIPTION

Referring now to the drawings submitted herewith, wherein various elements depicted therein are not necessarily drawn to scale and wherein through the views and figures like elements are referenced with identical reference numerals, there is illustrated an animal trap 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring to the Figures submitted as a part hereof, the animal trap 100 includes a frame 10 wherein the frame 10 is manufactured from a suitable durable material such as but not limited to metal. The frame 10 includes a first portion 11 and a second portion 12 that are similarly shaped wherein the first portion 11 and second portion 12 are movably secured utilizing fasteners 15 to support bar 20. The support bar 20 includes first end 18 and second end 19 that are perpendicular in orientation to the support bar 20. The first portion 11 includes first end 7 and second end 8 coupled to said support bar via the fasteners 15. Second portion 12 includes first end 2 and second end 3 movably secured to the support bar 20 via the fasteners 15. The first portion 11 and second portion 12 are generally u-shaped and are configured to be movable intermediate a first position and a second position. In the first position, the first portion 11 and second portion 12 are distal to each other and in axial alignment. In the second position the first portion 11 and second portion 12 are adjacent each other and generally perpendicular to the support bar 20 extending upward therefrom. The first portion 11 and second portion 12 are in the second position ensuing the engagement member 30 being depressed which will be further discussed herein. It is in the second position of the first portion 11 and second portion 12 of the frame 10 that an animal will have a leg or foot trapped therebetween.

The first portion 11 and second portion 12 further includes surface expansion members 13. The surface expansion members 13 are manufactured from a square metal rod and function to provide an increase in the surface area of the section of the first portion 11 and second portion 12 that will engage an animals leg or foot. The square shape of the surface expansion members 13 correlates with the shape of the first portion 11 and second portion 12 so as to provide a consistent surface expansion of the entire area. The surface expansion members 13 are secured to the first portion 11 and second portion 12 utilizing suitable durable techniques. The increase surface area provides a technique to provide force distribution of the first portion 11 and second portion 12 so as to reduce the potential for damage to the trapped animal. It should be understood within the scope of the present invention that the first portion 11 and second portion 12 could be manufactured in alternate shapes and sizes.

The first portion 11 and second portion 12 are moved from their first position to their second position facilitated by the engagement member 30 and executed by first spring assembly 40 and/or the second spring assembly 50. Engagement member 30 includes a foot pan 31 operably coupled to a mounting member 32 wherein the mounting member 32 is movably coupled to support member 33 via fastener 36. The foot pan 31 is manufactured from a rigid planar material such as but not limited to sheet metal. It should be understood within the scope of the present invention that the foot pan 31 could be formed in various shapes such as but not limited to rectangular, square or circular. The foot pan is superposed the mounting member 32. The mounting member 32 includes a leading edge 34 having engagement tab 35. The engagement tab 35 protrudes outward from the leading edge 34 and is operable to hold the frame 10 in a position wherein the first portion 11 and second portion 12 are generally flat and axially aligned. The mounting member 32 is movably coupled to the support member 33 via fastener 36. Fastener 36 is an outwardly positioned pivot point for the engagement member 30. This pivot point location and the resulting horizontal offset relationship with engagement tab 35, provides the advantage of leverage that allows for improved function and usability of the device. The offset distance between fastener 36 and engagement tab 35 in a range from 0.125 inches to 2.0 inches allows for a balance of angles and force between the components of the engagement member 30 so as to provide adjustability by way of varying the disengagement pressure, i.e. pressure on the foot pan 31 required to activate the invention.

As the foot pan 30 moves downward, the mounting member 32 pivots via fastener 36 and as such the engagement tab 35 retracts towards the center of the frame 10 releasing the biased first position of the frame 10 so as to move the first portion 11 and second portion 12 such that they are adjacent each other.

The first portion 11 and second portion 12 of the frame 10 are movable intermediate the first position and second position via the first spring assembly 40 and second spring assembly 50. The first spring assembly 40 and second spring assembly 50 are operable to move the first portion 11 and second portion 12 intermediate their first position and second position. The first spring assembly 40 and second spring assembly 50 are identically manufactured and as such a detailed description of one is as follows. The first spring assembly 40 includes shaft 41 wherein the shaft 41 extends across the first portion 11. The shaft 41 is secured to support bar 20 utilizing a u-bolt 43 secured with fasteners 44. While a u-bolt 43 is illustrated herein, it should be understood within the scope of the present invention that the shaft 41 could be positionably secured with an alternate fastener that is operable to provide fixed rotational adjustment of the shaft 41. The aforementioned configuration provides the ability to loosen one fastener 44 so as to allow the shaft to spin thus releasing the trap so as to act as a quick release safety feature. Additionally, this configuration provides the ability to reduce the tension on the shaft by slightly loosening the fasteners 44 thus providing the ability to adjust tension towards a targeted species so as to reduce the possibility of damage to the leg or foot thereof. The shaft 41 has a spring assembly 45 wherein the spring assembly 45 has a first portion 46 and a second portion 47. The spring assembly 45 is circumferentially secured to the shaft 41 wherein shaft 41 includes apertures 38,39 configured to receive opposing ends of the spring assembly 45 providing the biased coupling thereto. While the preferred embodiment illustrated and discussed herein deploys the opposing ends of the spring assembly 45 into apertures 38,39, it should be understood within the scope of the present invention that the spring ends could be secure to the shaft 41 utilizing alternative techniques. The spring assembly 45 further includes lever portion 48 wherein the lever portion 48 is a portion of the spring that is contiguously formed with the first portion 46 and second portion 47. The lever portion 48 extends outward from the frame 10 and provides a means to move the animal trap 100 from its second position to its closed position. The lever portion 48 includes arm sections 77,78 that extend over the upper surface of the frame 10. It should be understood within the scope of the present invention that the lever portion 48 could extend outward from the frame 10 in alternate distances. As previously mentioned herein, the second spring assembly 50 is identically manufactured as the first spring assembly 40 and is configured to provide contribution to the operation of the animal trap similarly to the first spring assembly 50. It should be understood within the scope of the present invention that the each of the first spring assembly 40 and second spring assembly 50 apply pressure to both the first portion 11 and second portion 12 of the frame 10.

The animal trap 100 further includes an anchor assembly 60 wherein the anchor assembly 60 is operable to secure the animal trap 100 to an appropriate anchor in order to inhibit the animal trap 100 from being moved subsequent the trapping of an animal therein. The anchor assembly 60 includes chain 61 wherein the chain 61 is rotatably secured to the support bar 20 via swivel connector 62. The swivel connector 62 facilitates the chain 61 from becoming entangled during movement of an animal ensuing being secured in the animal trap 100. The position of the swivel connector 62 being operably coupled to the support bar 20 ensures a maintenance of rotational integrity if a trapped animal is moving the animal trap 100 further providing a reduction in potential entanglement. It should be understood within the scope of the present invention that the chain 61 could be manufactured of various lengths and sizes.

As previously discussed herein, the fastener 43 and its u-bolt configuration provides for positional adjustment of the shaft 41 both for reducing the tension and increasing the tension of the first spring assembly 40 and second spring assembly 50. This allows to calibrate the animal trap 100 for alternate targeted species wherein the species may require different amounts of force to successfully trap yet inhibit damage thereto and further provide the ability to adjust for different climates. Positional adjustment of the shaft 41 should be understood to be able to rotate the shaft 41 and then secure in the position rotated to wherein this will either increase or decrease the tensions on the spring based on the rotated direction as the spring is secured to the shaft 41. A further advantage of the animal trap 100 is the ability to provide more force via the position of the arms 52,53 of the lever portion 48 relative to the pivot point of the fasteners 15. The distance intermediate the fasteners 15 and the opposing arms 52 provide an increase in the overall power of the animal trap 100 at its upper end of force range. In the preferred embodiment of the present invention the distance between the fastener 15 and as the pivot point and the arms 52,53 range from 0.25 inches to 2.0 inches. Placing the arms 52, 53 at this distance provides the ability to offer a greater force if desired through adjustment of the first spring assembly 40 and second spring assembly 50.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. An animal trap configured to secure an animal via a foot or leg wherein the animal trap comprises:
a frame, said frame having a first portion and a second portion, said first portion and said second portion being similarly shaped, said frame being movable intermediate a first position and a second position, said first portion having a first end and a second end, said second portion having a first end and a second end, said first portion being movable coupled to a support bar proximate the first end and second end thereof, said second portion being movably coupled to said support bar proximate the first end and second end thereof, said support bar having a first end and a second end;
a first spring assembly, said first spring assembly being secured to said support bar proximate said first end thereof, said first spring assembly having a shaft and a spring circumferentially secured thereto;
a second spring assembly, said second spring assembly being secured to said support bar proximate said second end thereof, said second spring assembly having a shaft, said second spring assembly having a spring circumferentially mounted to said shaft of said second spring assembly;
an engagement member, said engagement member having a foot pan, said foot pan being operably coupled to a mounting member, said mounting member having a leading edge configured to operably couple to said second portion of said frame, said engagement member operable to maintain said frame in said first position; and
wherein in said first position said first portion and said second portion of said frame are axially aligned and planar in configuration.

2. The animal trap as recited in claim 1, wherein said first spring assembly further includes a lever portion, said lever portion being contiguous with a first spring portion and a second spring portion and intermediate thereto, said lever portion of said first spring assembly extending beyond said first portion of said frame.

3. The animal trap as recited in claim 2, wherein said second spring assembly further includes a lever portion, said lever portion of said second spring assembly being contiguous with a first spring portion of the second spring assembly and a second spring portion of the second spring assembly and intermediate thereto, said lever portion of said second spring assembly extending beyond said second portion of said frame.

4. The animal trap as recited in claim 3, wherein said shaft of said first spring assembly is rotatably positionable via a fastener to said support bar.

5. The animal trap as recited in claim 4, and further including an anchor assembly, said anchor assembly further having a swivel connector, said swivel connector being rotatably secured to said support bar.

6. The animal trap as recited in claim 5, wherein said lever portion of said second spring assembly includes a first arm section and a second arm section, said first arm section being approximately 0.25 to 2.0 inches outwardly lateral of said first end of said first portion of said frame.

7. The animal trap as recited in claim 6, wherein said second arm section of said lever portion of said second spring assembly being approximately 0.25 to 2.0 inches outwardly lateral of said first end of said second portion of said frame.

8. The animal trap as recited in claim 7, wherein said shaft of said second spring assembly is rotatably positionable via a fastener to said support bar.

9. The animal trap as recited in claim 8, wherein said first portion of said frame further includes a surface expansion member, said surface expansion member being adjacent an interior surface of said first portion of said frame, said surface expansion member configured to distribute force distribution on a portion of an animal intermediate the first portion and second portion of the frame when said frame is in said second position.

10. The animal trap as recited in claim 9, wherein said lever portion of said first spring assembly includes a first arm section and a second arm section, said first arm section of said lever portion of said first spring assembly being approximately 0.25 to 2.0 inches outwardly lateral of said second end of said first portion of said frame.

11. The animal trap as recited in claim 10, wherein said first arm section of said lever portion of said second spring assembly being approximately 0.25 to 2.0 inches outwardly lateral of said second end of said second portion of said frame.

12. The animal trap as recited in claim 11, wherein said leading edge of said mounting member further includes an engagement tab, said engagement tab extending outward from said leading edge so as to overlap an upper surface of said second portion of said frame.

13. An animal trap configured with an adjustable tension so as to secure an animal via a foot or leg wherein the animal trap comprises:
a frame, said frame having a first portion and a second portion, said first portion and said second portion being similarly shaped, said frame being movable intermediate a first position and a second position, said first portion having a first end and a second end, said second portion having a first end and a second end, said first portion being movable coupled to a support bar proximate the first end and second end thereof, said second portion being movably coupled to said support bar proximate the first end and second end thereof, said support bar having a first end and a second end;
a first spring assembly, said first spring assembly being secured to said support bar proximate said first end thereof, said first spring assembly having a shaft and a spring circumferentially secured thereto, said spring having an upper portion and a lower portion said upper portion of said spring coupled to an aperture formed in an upper end of said shaft, said spring having a lower portion proximate a lower end of said shaft, said lower portion of said spring having an end coupled to an aperture proximate the lower end of said shaft, said first spring assembly having a lever portion, said lever portion being contiguously formed with said upper portion and said lower portion of said spring, said lever portion including an arm section wherein the arm section extends over an upper surface of the frame and outward therefrom;
a second spring assembly, said second spring assembly being secured to said support bar proximate said second end thereof, said second spring assembly having a shaft, said second spring assembly having a spring circumferentially mounted to said shaft of said second spring assembly, said spring of said second spring assembly having an upper portion and a lower portion, said upper portion of said second spring assembly proximate an upper end of said shaft of said second spring assembly, said lower portion of said spring of said second spring assembly being proximate a lower end of said shaft of said second spring assembly, said second spring assembly having a lever portion, said lever portion of said second spring assembly being contiguously formed with said upper portion and said lower portion of said spring of said second spring assembly, said lever portion of said second spring assembly including arm section wherein the arm section extends over the upper surface of the frame and outward therefrom;
an engagement member, said engagement member having a foot pan, said foot pan being operably coupled to a mounting member, said mounting member pivotally coupled to a support member distal to said foot pan via a fastener, said mounting member having a leading edge forming an engagement tab wherein the engagement tab is configured to operably couple to said second portion of said frame, said engagement member operable to maintain said frame in said first position; and
wherein in said second position of said frame said first portion and said second portion are adjacent.

14. The animal trap configured with an adjustable tension so as to secure an animal via a foot or leg as recited in claim 13, wherein said arm section of said lever portion of said first spring assembly being approximately 0.25 to 2.0 inches outwardly lateral of said second end of said first portion of said frame and said second end of said second portion of said frame.

15. The animal trap configured with an adjustable tension so as to secure an animal via a foot or leg as recited in claim 14, wherein said arm section of said lever portion of said second spring assembly being approximately 0.25 to 2.0 inches outwardly lateral of said first end of said second portion and said first portion of said frame.

16. The animal trap configured with an adjustable tension so as to secure an animal via a foot or leg as recited in claim 15, and further including an anchor assembly, said anchor assembly further having a swivel connector, said swivel connector being rotatably secured to said support bar.

17. The animal trap configured with an adjustable tension so as to secure an animal via a foot or leg as recited in claim 16, wherein said shaft of said first spring assembly is rotatably positionable via a fastener to said support bar.

18. The animal trap configured with an adjustable tension so as to secure an animal via a foot or leg as recited in claim 17, wherein said shaft of said second spring assembly is rotatably positionable via a fastener to said support bar.

19. The animal trap configured with an adjustable tension so as to secure an animal via a foot or leg as recited in claim 18, wherein the engagement tab is horizontally offset from the fastener on said mounting member approximately 0.125 to 2.0 inches.
